(19) United States
(12) Patent Application Publication
(10) Pub. No.: US 2012/0254662 A1
(43) Pub. Date: Oct. 4, 2012

(54) AUTOMATED TEST SYSTEM AND AUTOMATED TEST METHOD

(75) Inventor: Fei-Teng CHEN, New Taipei City (TW)

(73) Assignee: WISTRON CORP., New Taipei City (TW)

(21) Appl. No.: 13/222,217

(22) Filed: Aug. 31, 2011

(30) Foreign Application Priority Data
Mar. 28, 2011 (TW) 100110548

(51) Int. Cl. G06F 11/263

(52) U.S. Cl. 714/32; 714/E11.177

(57) ABSTRACT

The invention provides an automated test method for testing a server. In one embodiment, the server comprises a plurality of sensors, a preboot Dynamic System Analyzer (pDSA), and a Baseborad Management Controller (BMC). First, a connection is built with the server via a network. A remote control program is then used to display a user interface of the pDSA on a screen. A keyboard-mouse automation program is then used to control a keyboard to perform a series of keyboard control operations and control a mouse to perform a series of mouse control operations for simulating user instructions. The remote control program is then used to send the keyboard control operations and the mouse control operations to the server via the network, thereby controlling the pDSA to perform testing of the sensors of the server to generate a test log.

### CROSS REFERENCE TO RELATED APPLICATIONS

This Application claims priority of Taiwan Patent Application No. 100110548, filed on Mar. 28, 2011, the entirety of which is incorporated by reference herein.

### BACKGROUND OF THE INVENTION

1. Field of the Invention

The invention relates to testing, and more particularly to testing automation.

2. Description of the Related Art

When a server manufactured by International Business Machine (IBM) breaks down, a client uses preboot Dynamic System Analyzer (pDSA) to collect operation information of the server, and sends the operation information of the server to a repair company. The repair company then determines the problem of the server according to the operation information, and then fixes the server. To ensure accurate operation information of the server, a testing engineer of the repair company performs a series of tests on the server according to the pDSA.

It takes a long time for a testing engineer to run tests on a server. Referring to FIG. 1, a block diagram of an IBM server 100 being tested is shown. The IBM server 100 comprises a Baseboard Management Controller (BMC) 102, a preboot Dynamic System Analyzer (pDSA) 106 stored in a flash memory 104, and a plurality of sensors 121˜12X. In one embodiment, the sensors 121˜12X are divided into a group of X3550M2 sensors and a group of X3560M2 sensors. In one embodiment, the server 100 comprises 117 X3550M2 sensors and 116 X3560M2 sensors.

When testing of the server is performed, the testing engineer connects a screen 150, a keyboard 160, a mouse 180, and a USB storage device 170 to the server 100. After the server 100 is booted, the testing engineer presses a specific key of the keyboard 160 to execute a pDSA program 106. When the server 100 executes the pDSA 106, a user interface of the pDSA 106 is shown on the screen 150. The testing engineer must input instructions and move the cursor via the user interface to control the pDSA 106 to perform testing of the sensors 121˜12X.

The pDSA 106 sequentially performs testing on the sensors 121˜12X. Thus, the testing engineer must input instructions to sequentially test the sensors 121˜12X. When a target sensor is tested, the testing engineer must manually set the testing parameters and adjust offset values of the target sensor via the user interface of the pDSA 106. The testing engineer therefore must perform a lot of inputs via the keyboard 160 and the mouse 180. After testing of the target sensor is completed, the server 100 writes a test log 172 of the target sensor to the USB storage device 170. A repair engineer can then fix problems of the servers according to the test log 172 stored in the USB storage device 170.

A testing engineer ordinarily spends about 30 minutes on testing of a single sensor. An entire testing process of all 233 sensors of the server 100 therefore requires a testing period of 116 hours which is equal to almost 15 working days. To save effort and time of a testing engineer, an automated testing system which can control the pDSA 106 to automatically complete testing of the sensors 121˜12X of the server 100 is therefore required.

### BRIEF SUMMARY OF THE INVENTION

The invention provides an automated test system. In one embodiment, the automated test system is coupled to a server to be tested via a network, and comprises a screen, a keyboard-mouse automation program, a remote control program, and a microprocessor. The server comprises a plurality of sensors, a preboot Dynamic System Analyzer (pDSA), and a Baseborad Management Controller (BMC). The keyboard-mouse automation program controls a keyboard to perform a series of keyboard control operations, and controls a mouse to perform a series of mouse control operations. The remote control program sends the keyboard control operations and the mouse control operations to the server via the network. The microprocessor uses the remote control program to display a user interface of the pDSA on the screen, uses the keyboard-mouse automation program to generate the keyboard control operations and mouse control operations simulating user instructions, and uses the remote control program to send the keyboard control operations and the mouse control operations to the server, thereby controlling the pDSA to perform testing of the sensors of the server to generate a test log.

The invention also provides an automated test method for testing a server. In one embodiment, the server comprises a plurality of sensors, a preboot Dynamic System Analyzer (pDSA), and a Baseborad Management Controller (BMC). First, a connection is built with the server via a network. A remote control program is then used to display a user interface of the pDSA on a screen. A keyboard-mouse automation program is then used to control a keyboard to perform a series of keyboard control operations and control a mouse to perform a series of mouse control operations for simulating user instructions. The remote control program is then used to send the keyboard control operations and the mouse control operations to the server via the network, thereby controlling the pDSA to perform testing of the sensors of the server to generate a test log.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of an IBM server being tested;

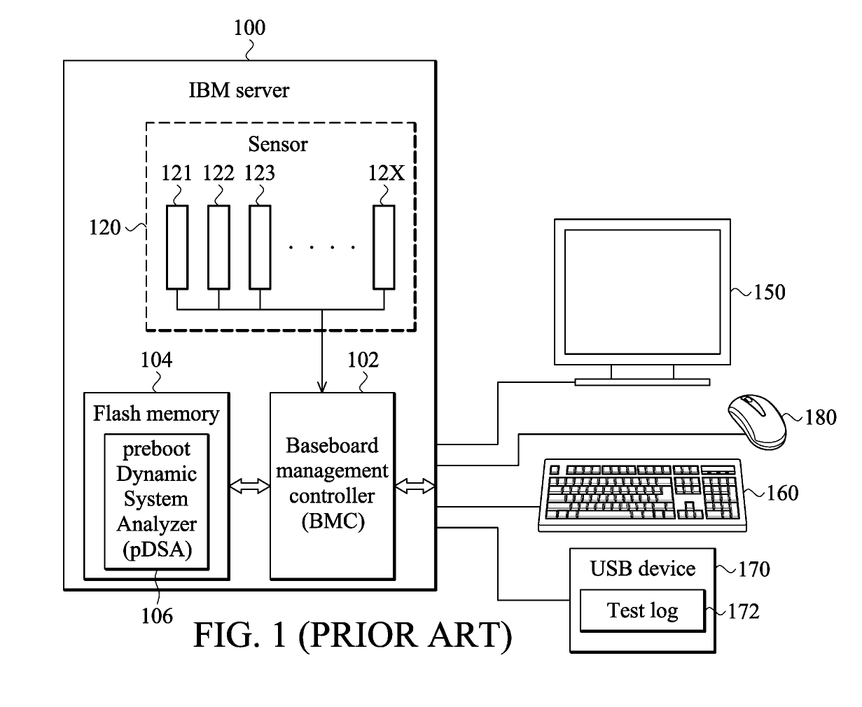

FIG. 2 is a block diagram of an automated test system according to the invention;

FIG. 3 is a flowchart of an operating method of a pDSA program according to the invention;

FIG. 4 is a flowchart of a method for performing an automated test on a server according to the invention;

FIG. 5 is a schematic diagram of an embodiment of a segment of a sensor test configuration file according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

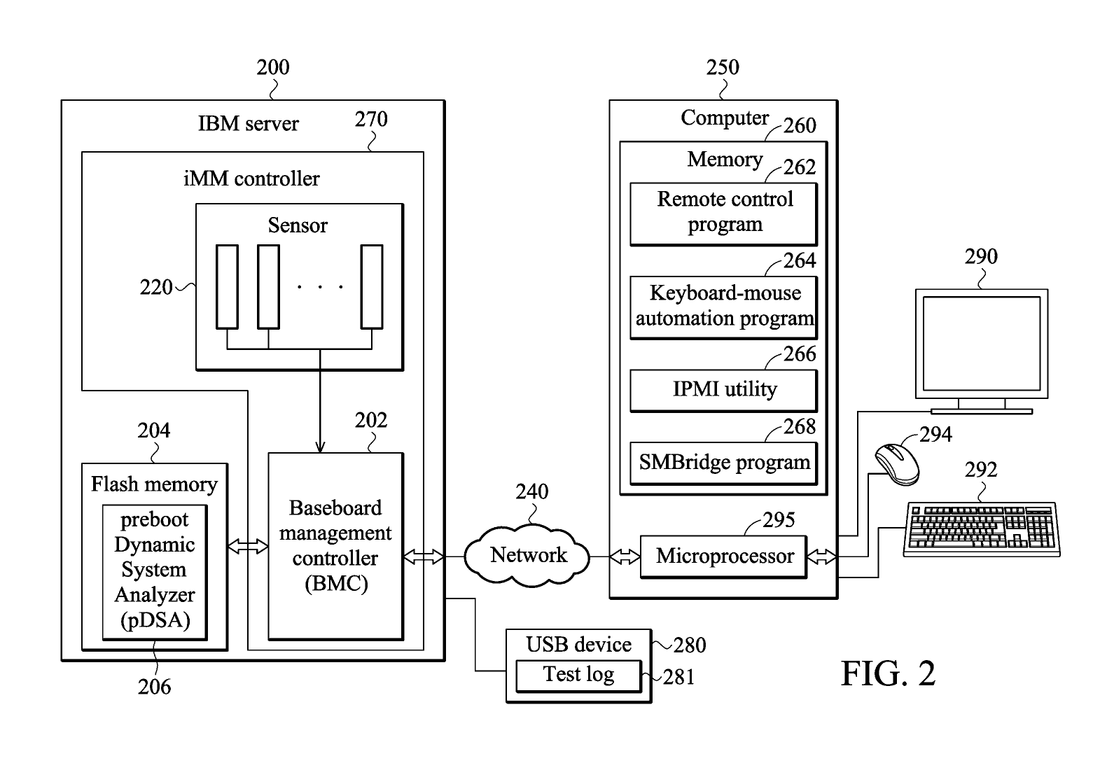

Referring to FIG. 2, a block diagram of an automated test system according to the invention is shown. The automated test system is coupled to a server 200 manufactured by International Business Machines (IBM) via a network 240. In one embodiment, the automated test system comprises a computer 250, a screen 290, a keyboard 292, a mouse 294, and a USB storage device 280. The screen 290, the keyboard 292, the mouse 294, and the USB storage device 280 are coupled to the computer 250. In one embodiment, the computer 250 comprises a memory 260 and a microprocessor 295. A remote control program 262, a keyboard-mouse automation program 264, an Intelligent Platform Management Interface (IPMI) utility program 266, and a System management Bridge (SMBridge) program 268 are stored in the memory 260.

In one embodiment, the IBM server 200 comprises a Baseboard Management Controller (BMC) 202, a flash memory 204 storing a preboot Dynamic System Analyzer (pDSA) 206, and a plurality of sensors 220. An iMM controller 270 comprises the BMC 202 and the sensors 220. In one embodiment, the sensors 220 are divided into a group of X3550M2 sensors and a group of X3560M2 sensors. In one embodiment, the IBM server 200 comprises 117 X3550M2 sensors and 116 X3560M2 sensors. Thus, there are 233 sensors to be tested in the IBM server 200.

The pDSA 206 performs testing of the server 200. When the pDSA 206 is executed, the pDSA 206 sequentially performs testing on the sensors 220. After the pDSA 206 is activated, the pDSA 206 clears event logs, triggers events, and collects event logs from the server 200. Event logs are testing results of sensors and show whether the sensors have passed or failed tests. When the event logs are cleared, the BMC 202 removes all of the event logs from the server 200. When the events are triggered, the BMC 202 generates IPMI commands to perform tests on the sensors 220 to generate event logs. When the event logs are collected, the event logs generated by the BMC 202 are read out from the server 200 by the SMBridge program 268. The microprocessor 295 executes the IPMI utility 266 stored in the memory 260 to generate IPMI commands which are sent to the BMC 202. When the BMC 202 receives the IPMI commands, the BMC 202 is controlled to clear event logs, trigger events, and collect event logs according to the IPMI commands.

The pDSA 206 has a user interface for receiving testing parameters and offset values of sensors 220. When the pDSA 206 performs testing on the sensors 220, the microprocessor 295 executes the remote control program 262 to extract the user interface of the pDSA 206 from the server 200 via the network 240 and displays the user interface of the pDSA 206 on the screen 290. In one embodiment, the remote control program 262 is a Remote Keyboard, Visual Display, and Mouse (Remote KVM) program. Testing parameters and offset values of sensors 220 can then be input via the user interface shown on the screen 290 to control the pDSA 206 to perform testing of the sensors 220.

The keyboard-mouse automation program 264 controls the keyboard 292 to perform a series of keyboard control operations, and controls the mouse 294 to perform a series of mouse control operations. In one embodiment, the keyboard-mouse automation program 264 is AutoIt program. After the remote control program 262 shows the user interface of the pDSA 206 on the screen 290, the microprocessor 295 executes the keyboard-mouse automation program 264 to simulate a series of keyboard control operations and a series of mouse control operations of a testing engineer. The remote control program 262 then sends the keyboard control operations and the mouse control operations to the server 200 via the network 240 to control the pDSA 204.

After the server 200 receives the keyboard control operations and the mouse control operations from the network 240, the pDSA 206 performs testing on the sensors 220 according to the testing parameters and offset values input by the keyboard control operations and the mouse control operations, and then collects the test result to generate a test log. The SMBridge program 268 then downloads the test log from the server 200 via the network 240 to the computer 250. In one embodiment, a Universal Serial Bus (USB) storage device 280 is coupled to the computer 250 via a USB interface. After the test log is downloaded to the computer 250, the microprocessor 295 writes the test log to the USB storage device 280. Thus, a repair engineer can analyze errors of the server 200 according to the test log 281 stored in the USB storage device 280 and then repair the server 200.

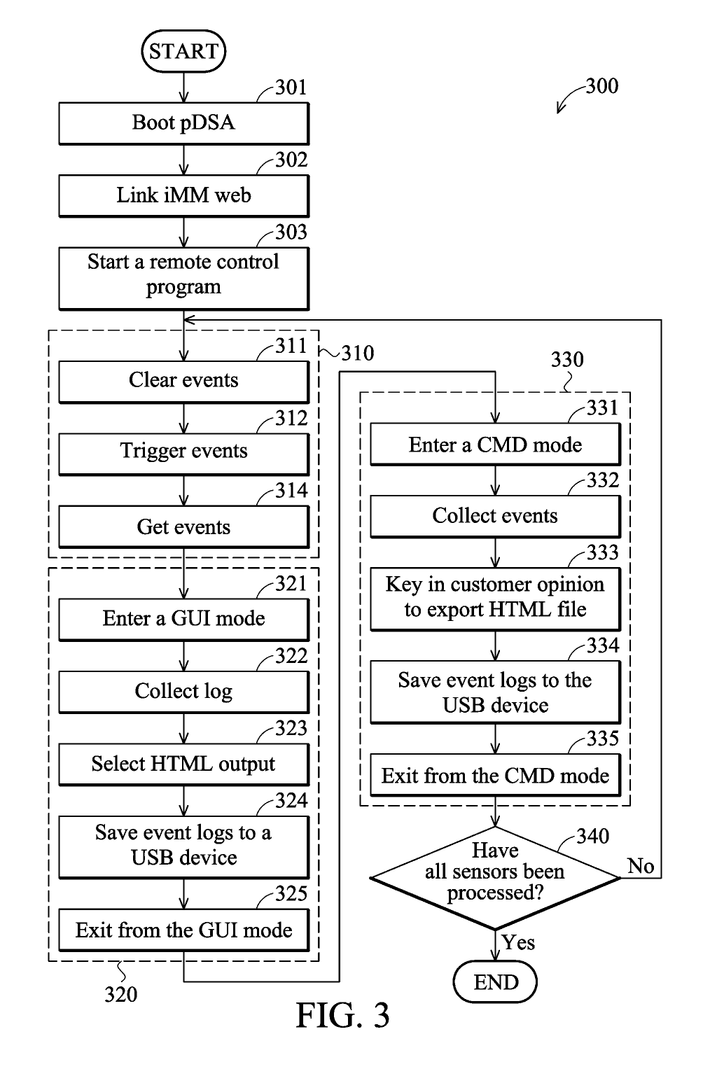

Referring to FIG. 3, a flowchart of an operating method of the pDSA program 206 according to the invention is shown. First, the pDSA 206 stored in the memory 204 of the server 200 is started (step 301). A link to a web page of an Integrated Management Module (iMM) is then built (step 302). The microprocessor 295 of the computer 250 then activates the remote control program 262 (step 303) to send a series of keyboard control operations and mouse control operations to the server 200 via the network 240 and to extract the user interface of the pDSA 206 from the server 200.

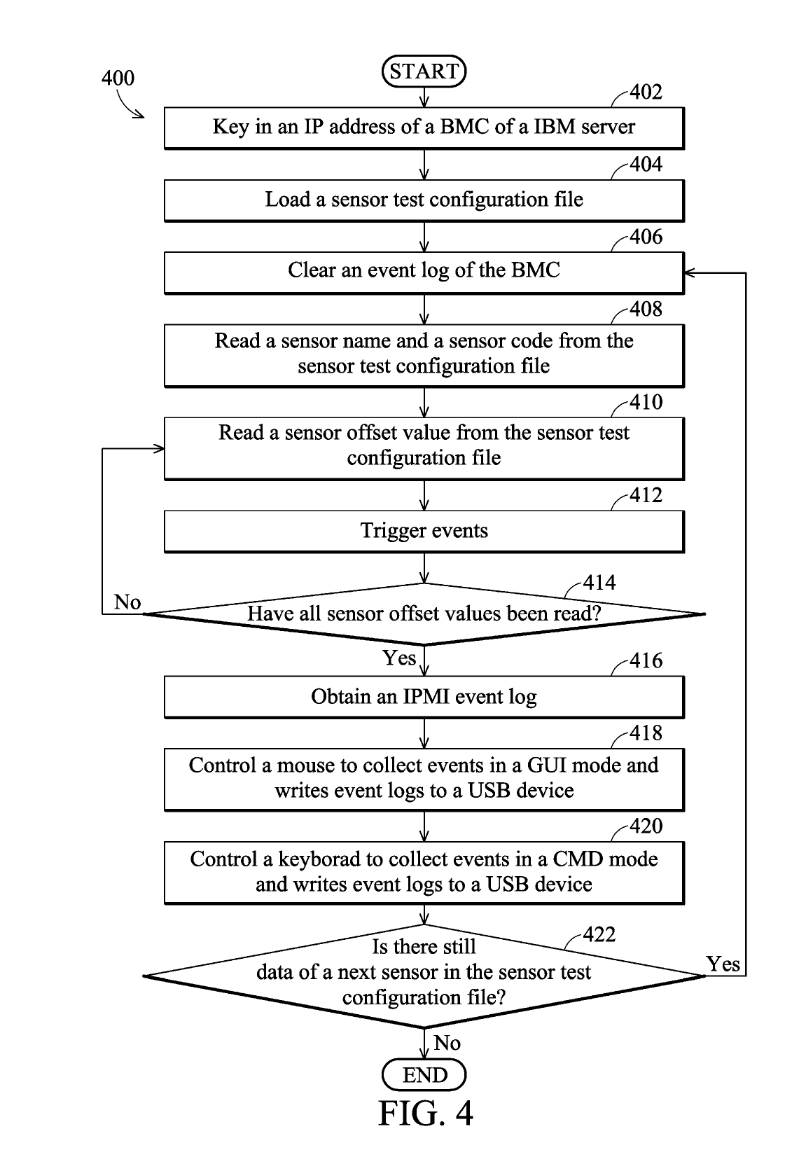

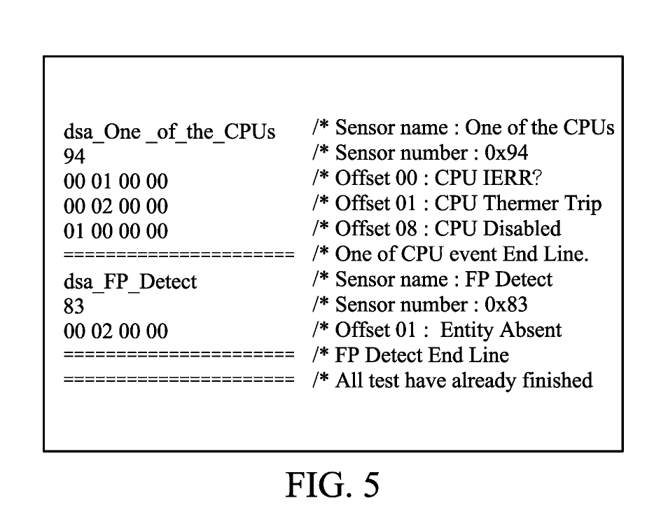

The microprocessor 295 of the computer 250 then executes the IPMI utility program 266 to send a series of IPMI commands to the server 200 to control the BMC 202 to clear event logs (step 311), trigger events (step 312), and collect event logs (step 314) according to the IPMI commands. The flow of sending IPMI commands in steps 311, 312, and 314 is further illustrated with FIGS. 4 and 5.

The user interface of the pDSA 206 then enters a Graphic User Interface (GUI) mode (step 321). In the GUI mode, the microprocessor 295 executes the keyboard-mouse automation program 264 to generate a series of mouse control operations to control the pDSA 206 to perform testing on the sensors 220. The sever 200 then collects testing results as event logs (step 322). The keyboard-mouse automation program 264 then generates a mouse control operation to select an HTML output format (step 323). The keyboard-mouse automation program 264 then generates a mouse control operation to write the event logs to the USB storage device 280 (step 324). The user interface of the pDSA 206 then exits from the GUI mode (step 325).

The user interface of the pDSA 206 then enters a command (CMD) mode (step 331). In the CMD mode, the microprocessor 295 executes the keyboard-mouse automation program 264 to generate a series of keyboard control operations to control the pDSA 206 to perform testing on the sensors 220. The sever 200 then collects testing results as event logs (step 332). The keyboard-mouse automation program 264 then generates a keyboard control operation to key in customer opinions to export an HTML file (step 333). The keyboard-mouse automation program 264 then generates a keyboard control operation to write the event logs to the USB storage device 280 (step 334). The user interface of the pDSA 206 then exits from the CMD mode (step 335). If all sensors 220 have been tested (step 340), testing of the server 200 is completed. If any of the sensors 220 have not been tested, the microprocessor 295 of the computer 250 then executes steps 311˜335 again to control the pDSA 206 to perform testing on the sensors 220 of the server 200.

Referring to FIG. 4, a flowchart of a method 400 for performing an automated test on the server 200 according to the invention is shown. The method 400 is a detailed embodiment of the method 300. First, a testing engineer must key in an IP address of the BMC 202 of the server 200 with the keyboard 292 (step 402). The microprocessor 295 of the computer 250 then loads a sensor test configuration file to a memory 260 of the computer 250 (step 404). Referring to FIG. 5, a schematic diagram of an embodiment of a segment of a sensor test configuration file according to the invention is shown. The sensor test configuration file is a text file, and the texts of the sensor test configuration file records the testing parameters and offset values comprised by IPMI commands sent by the computer 250 to the BMC 202 of the sever 200. For example, the sensor test configuration file of FIG. 5 comprises testing parameters of two sensors. The testing parameters of the two sensors are separated by the separation line “===================”. The first line after the separation line records a name of a sensor, a second line records an identification number of the sensor, and subsequent lines record offset values of a testing process of the sensor. For example, the name of a first sensor of the sensor text configuration file is “One of the CPUs”, the identification number of the first sensor is “0x94”, the name of a second sensor of the sensor text configuration file is “FP detect”, the identification number of the second sensor is “0x83”.

After the sensor test configuration file is loaded to the memory 260, the microprocessor 295 sends IPMI commands to the BMC 202 to control the BMC 202 to clear event logs (step 406). For example, the microprocessor 295 sends the following IPMI command to control the BMC 202 to clear event logs:

showsel -N BMC_IP -U USERID -P PASSW0RD -C;

When the BMC 202 generates a response to indicate that the event log has been cleared, the microprocessor 295 reads a sensor name and a sensor identification number from the sensor test configuration file (step 408). The microprocessor 295 then reads an offset value from a next line of the sensor test configuration file (step 410). The microprocessor 295 then generates IPMI commands according to the sensor name, the sensor identification number, and the offset value, and sends the IPMI commands to the BMC 202 to control the BMC 202 to trigger events (step 412). For example, the microprocessor 295 sends the following IPMI command to the BMC 202 to trigger events:

icmd -N BMC_IP -U USERID -P PASSWORD 00 20 E8 17 00 ;
icmd -N BMC_IP -U USERID -P PASSWORD 00 20 E8 17 05
Sensor number ;
icmd -N BMC_IP -U USERID -P PASSWORD 00 20 E8 17 01
Sensor number

Offset ;

If there are still offset values in the subsequent lines of the sensor test configuration file (step 414), the microprocessor 295 reads the offset value from the next line of the sensor text configuration file (step 410), and generates an IPMI command according to the offset value to control the BMC 202 to trigger events (step 412).

When there is no offset value in the subsequent lines of the sensor test configuration file (step 414), the microprocessor 295 sends an IPMI command to the BMC 202 to control the BMC 202 to collect event logs (step 416). For example, the microprocessor 295 sends the following IPMI command to the BMC 202 to collect event logs:

smbridge -n BMC_IP -u USERID -p PASSWORD sel get;

The keyboard-mouse automation program 264 then automatically generates mouse control operations to control the server 200 to collect event logs in a GUI mode of the user interface, and writes the event logs to the USB storage device 280 (step 418). The keyboard-mouse automation program 264 then automatically generates keyboard control operations to control the server 200 to collect event logs in a CMD mode of the user interface, and writes the event logs to the USB storage device 280 (step 420). Finally, if there are still data of a next sensor in the sensor test configuration file (step 422), the microprocessor 295 repeats the steps 406˜420 to control the BMC 202 to perform testing of the next sensor of the server 200.

The computer 250 can control the BMC 202 and the pDSA program 206 of the server 200 to automatically perform testing on a plurality of sensors 220 of the server 200. For example, an IBM server comprises 233 sensors, and testing of the 233 sensors requires a testing period of 116 hours. Because the computer 250 of the invention can automatically perform testing on the server without a test engineer, the efforts and time of the testing engineer is saved.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An automated test system, coupled to a server to be tested via a network, wherein the server comprises a plurality of sensors, a preboot Dynamic System Analyzer (pDSA), and a Baseborad Management Controller (BMC), comprising:
a screen;
a keyboard-mouse automation program, stored in a memory, controlling a keyboard to perform a series of keyboard control operations, and controlling a mouse to perform a series of mouse control operations;
a remote control program, stored in the memory, sending the keyboard control operations and the mouse control operations to the server via the network; and
a microprocessor, connected to the server, using the remote control program to display a user interface of the pDSA on the screen, using the keyboard-mouse automation program to generate the keyboard control operations and mouse control operations simulating user instructions, and using the remote control program to send the keyboard control operations and the mouse control operations to the server, thereby controlling the pDSA to perform testing of the sensors of the server to generate a test log.

2. The automated test system as claimed in claim 1, wherein the automated test system further comprises:
an Intelligent Platform Management Interface (IPMI) utility program, stored in the memory;
wherein the microprocessor uses the IPMI utility program to send a series of IPMI command to the BMC of the server to control the BMC to clear event logs, trigger events, and collect event logs.

3. The automated test system as claimed in claim 2, wherein the automated test system further comprises:
a sensor test configuration file, storing identification codes of the sensors and offsets of the sensors,
wherein the microprocessor reads the sensor test configuration file, and generates the IPMI commands which are sent to the BMC according to the identification codes of the sensors and the offsets of the sensors, thereby controlling the BMC to perform testing of the sensors.

4. The automated test system as claimed in claim 1, wherein when the user interface of the pDSA enters a Graphic User Interface (GUI) mode, the microprocessor uses the keyboard-mouse automation program to generate the mouse control operations to control the pDSA to perform testing of the sensors of the server.

5. The automated test system as claimed in claim 1, wherein when the user interface of the pDSA enters a Command (CMD) mode, the microprocessor uses the keyboard-mouse automation program to generate the keyboard control operations to control the pDSA to perform testing of the sensors of the server.

6. The automated test system as claimed in claim 3, wherein the automated test system further comprises:
a System Management Bridge (SMBridge) program, stored in the memory,
wherein when the pDSA completes testing of the sensors, the microprocessor uses the SMBridge program to download the test log to the automated test system.

7. The automated test system as claimed in claim 1, wherein the automated test system further comprises:
a Universal Serial Bus (USB) storage device, coupled to the automated test system via a USB interface, storing the test log.

8. The automated test system as claimed in claim 1, wherein the remote control program is a Remote Keyboard, Visual Display, and Mouse (Remove KVM) program.

9. An automated test method, for testing a server, wherein the server comprises a plurality of sensors, a preboot Dynamic System Analyzer (pDSA), and a Baseborad Management Controller (BMC), comprising:
building a connection with the server via a network;
using a remote control program to display a user interface of the pDSA on a screen,
using a keyboard-mouse automation program to control a keyboard to perform a series of keyboard control operations and control a mouse to perform a series of mouse control operations for simulating user instructions; and
using the remote control program to send the keyboard control operations and the mouse control operations to the server via the network, thereby controlling the pDSA to perform testing of the sensors of the server to generate a test log.

10. The automated test method as claimed in claim 9, wherein the automated test method further comprises:
using an Intelligent Platform Management Interface (IPMI) utility program to send a series of IPMI command to the BMC of the server to control the BMC to clear event logs, trigger events, and collect event logs.

11. The automated test method as claimed in claim 10, wherein the automated test method further comprises:
using a sensor test configuration file to store identification codes of the sensors and offsets of the sensors; and
generating the IPMI commands which are sent to the BMC according to the identification codes of the sensors and the offsets of the sensors to control the BMC to perform testing of the sensors.

12. The automated test method as claimed in claim 9, wherein the automated test method further comprises:
when the user interface of the pDSA enters a Graphic User Interface (GUI) mode, using the keyboard-mouse automation program to generate the mouse control operations to control the pDSA to perform testing of the sensors of the server.

13. The automated test method as claimed in claim 9, wherein the automated test method further comprises:
when the user interface of the pDSA enters a Command (CMD) mode, using the keyboard-mouse automation program to generate the keyboard control operations to control the pDSA to perform testing of the sensors of the server.

14. The automated test method as claimed in claim 9, wherein the automated test method further comprises:
when the pDSA completes testing of the sensors, using a System Management Bridge (SMBridge) program to download the test log to the automated test system.

15. The automated test method as claimed in claim 9, wherein the automated test method further comprises:
using a Universal Serial Bus (USB) storage device coupled to the automated test system via a USB interface to store the test log.

16. The automated test method as claimed in claim 9, wherein the remote control program is a Remote Keyboard, Visual Display, and Mouse (Remove KVM) program.
